(19) United States
(12) Patent Application Publication
(10) Pub. No.: US 2021/0308936 A1
(43) Pub. Date: Oct. 7, 2021

(54) THREE-DIMENSIONAL PRINTING OF TEXTURE IMAGES

(71) Applicant: Hewlett-Packard Development Company, L.P., Spring, TX (US)

(72) Inventors: Alvaro VINACUA PLA, Barcelona (ES); Antonio CHICA CALAF, Barcelona (ES); David DURAN ROSICH, Sant Cugat del Valles (ES); Victor ANTON DOMINGUEZ, Sant Cugat del Valles (ES); Sergio GONZALEZ MARTIN, Sant Cugat del Valles (ES); Alex CARRUESCO LLORENS, Sant Cugat del Valles (ES); Jordi GONZALEZ ROGEL, Sant Cugat del Valles (ES)

(21) Appl. No.: 17/057,401

(22) PCT Filed: Jul. 31, 2018
(86) PCT No.: PCT/US2018/044509

§ 371 Date: Nov. 20, 2020

(51) Int. Cl. B29C 64/10; B33Y 10/00; B33Y 50/02; B29C 64/393

(52) U.S. Cl. CPC B29C 64/10; B33Y 10/00; B33Y 80/00; B29C 64/393; B33Y 50/02

(57) ABSTRACT

Examples of the present disclosure relate to a method in a three-dimensional printer for printing texture images. Lower resolution images of a texture image from a print file are generated and then selected based on volume pixels to be printed.

### BACKGROUND

A three-dimensional (3D) printer may print a 3D object from an input 3D print file. The 3D print file may comprise characteristics of the 3D object to be printed such as size, shape, material or colour. The texture of a 3D object may comprise the colour and/or material of the 3D object.

### BRIEF DESCRIPTION OF THE DRAWINGS

Various features of the present disclosure will be apparent from the detailed description which follows, taken in conjunction with the accompanying drawings, which together illustrate, features of certain examples, and wherein:

FIG. 1 is a schematic representation of an example of a texture image;

FIGS. 2a-c are schematic representations of an example of mapping a texture image to a surface;

FIG. 3 is a schematic representation of an example of a 3D model;

FIG. 4 is a schematic representation of an example of mapping a texture image to a 3D model;

FIG. 5 is an example of a mipmapped texture image;

FIG. 6 is an example of an anisotropically mipmapped texture image;

FIGS. 7a-c are schematic representations of an example of mapping a lower resolution texture image to a 3D model;

FIGS. 8a-e are schematic representations of examples of extending texture images;

FIG. 9 is a block diagram of an example of a method in a 3D printer;

FIG. 10 is an example of a flowchart of a method in a 3D printer;

FIG. 11 is an example of a schematic diagram of a processor and machine-readable storage medium in a 3D printer; and

FIG. 12 is an example of a schematic diagram of a 3D printing system.

### DETAILED DESCRIPTION

Certain examples described herein allow the mapping of a texture image onto the surface of a 3D object to be generated by a 3D printer, and the 3D printing of texture images by a 3D printer. Application of a texture image to a 3D object can be achieved in a 3D printing process by taking into account both the resolution of the texture image, and additionally the print resolution of the 3D printer. In particular, in certain examples the process may involve generating lower resolution texture images and selecting, from the lower resolution texture images, an appropriate resolution of the texture image, which in turn can enable a more accurate and faithful reproduction of the texture image by a 3D printer.

In certain examples, the lower resolution texture images may be generated by anisotropically mipmapping the texture image to create anisotropically lower resolution texture images. In such examples, using an anisotropically lower resolution texture image may reduce the appearance of artefacts in the printed texture image that may otherwise occur when printing a texture image onto a 3D object with a higher resolution.

In certain examples, different resolutions of the texture image may be selected for different parts of the 3D printing process. This allows the 3D printer to use the most appropriate resolution of the texture image for each part of the printed 3D object.

A 3D print file may comprise a 3D model of a 3D object to be printed by a 3D printer. The 3D model may be generated by any such computer aided design (CAD), computer aided manufacturing (CAM) or computer aided engineering (CAE) application. In some examples, the 3D model of the 3D object may comprise a polygon mesh, for example a triangular mesh, that faithfully and efficiently reproduces the 3D object.

The 3D print file may further comprise a texture image to be applied to the 3D object in the printing of the 3D object. In some examples, the 3D print file may be in a 3D Manufacturing Format (3MF) file format. Furthermore, the 3D print file may comprise the 3MF Materials and Properties Extension specification which in turn may specify the texture image.

The 3D printer may generate a 3D print model from the 3D print file (comprising the 3D model and the texture image), based on the characteristics of the 3D printer. From the 3D print model, the 3D printer may print the 3D object with the applied texture image.

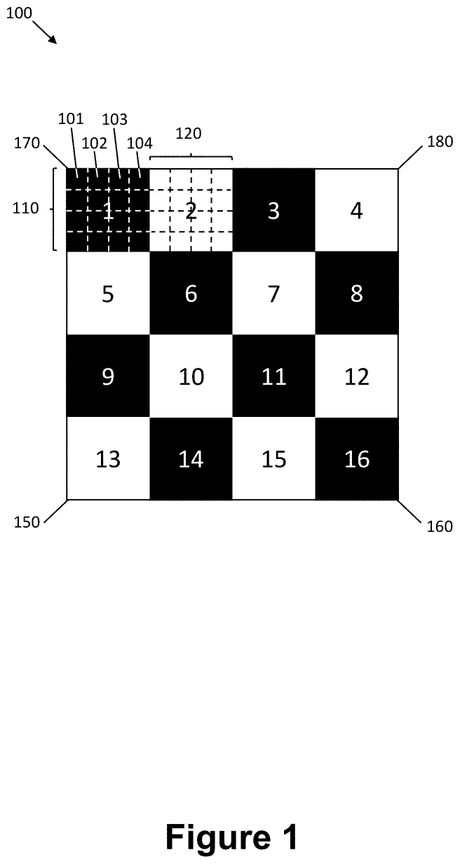

FIG. 1 is a schematic representation of an example of a texture image. A texture image 100 can be considered to be a two-dimensional (2D) image displaying a variation of one or more parameters in x and/or y dimensions. The parameters of the texture image 100 may be, for example, colours from a colour model such as an RGB or CMYK colour model to be applied to the surface of the 3D object during the 3D printing process. Alternatively, parameters of the texture image may be the material used by the 3D printer to create the 3D object in the 3D printing process.

A picture image comprises a 2D grid of picture elements or pixels. By analogy, a texture image comprises a 2D grid of texture pixels, which may be referred to as texture elements or texels 101, 102, 103, 104 etc.

The texture image 100 of the example is a black and white numbered checkerboard image. Such texture images may be referred to as artificial texture images as they are artificially created i.e. computer generated. Examples of natural texture images may be leaves, bark, grass i.e. natural scenes captured in an image. The parameters of the example texture image 100 are monochromatic black and white i.e. every texel 101, 102, 103, 104 etc. has a value of either black or white.

The texture image 100 includes a square grid 110 of 16 texels (the top row of texels are labeled 101, 102, 103, and 104) that form a black square numbered ‘1’. The texture image 100 also includes a square grid 120 of 16 further texels forming a white square numbered ‘2’. Although not shown for simplicity, it is to be understood that the grid of texels extends across the whole of the texture image 100. Indeed, it is the grid of texels that create the texture image. Furthermore, the texels 101, 102, 103, 104 etc. illustrated on the texture image 100 are enlarged compared to a typical image so that the individual texels of the texture image can be seen more clearly in the Figure.

The size of the texels of a texture image 100 determines the resolution of the texture image i.e. for a given absolute size of texture image, the smaller the size of the texels in the texture image, the higher the resolution of the texture image. The resolution of the texture image can be referred to as the number of texels wide (the x dimension) and the number of texels high (the y dimension). For example, with the enlarged texels of FIG. 1, the resolution of the texture image 100 is shown to be 16×16. In reality, the resolution will be considerably higher e.g. 256×256 or 512×512.

A texture image 100 may be assigned texture coordinates. For example, the bottom-left corner 150 of the texture image 100 may be assigned the coordinates (0,0), the bottom-right corner 160 assigned the coordinates (1,0), the top-left corner 170 assigned the coordinates (0,1), and the top-right corner 180 assigned the coordinates (1,1). The texture coordinates may be selected between the coordinates (0,0) to (1,1) allowing any location on the texture image 100 to be identified. Defining texture coordinates 150, 160, 170, 180 of the texture image 100 allows the whole or part of the texture image 100 to be orientated and mapped.

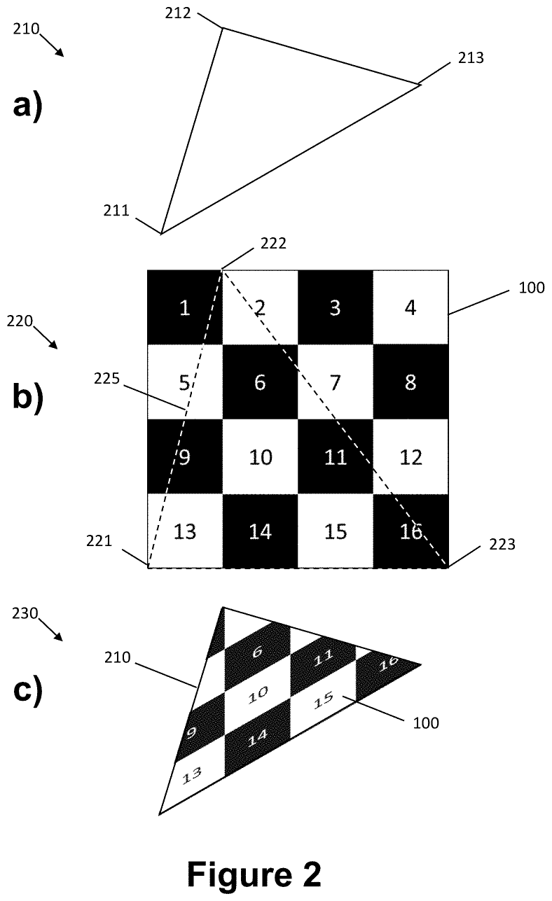

FIGS. 2a-c are schematic representations of an example of mapping a texture image 100 to a surface 210. The surface 210 may be a 2D surface of a 3D model. The surface may take a variety of different shape i.e. triangles, squares, rectangles, polygons etc. In the example of FIGS. 2a-c, the surface 210 takes the shape of a triangle.

The surface 210 is represented by a triangle with three vertices 211, 212, 213. The three vertices 211, 212, 213 of the triangular surface 210 may be assigned the coordinates in 3D space of (x₁, y₁, z₁) for the vertex 211, (x₂, y₂, z₂) for the vertex 212 and (x₃, y₃, z₃) for the vertex 213. Using the coordinates in combination with the texture coordinates described in relation to FIG. 1 allows the mapping of the texture image to the surface.

The vertices 211, 212, 213 of the triangular surface 210 may be mapped onto the texture image 100, to create a mapped triangle 225 as illustrated by the dashed line. Note the difference in the shape of the triangular surface 210 and its mapping onto the texture image, mapped triangle 225. The mapped triangle 225 may be assigned the texture coordinates 221, 222, 223. The three vertices 221, 222, 223 of the triangle 225 may be assigned the texture coordinates (u₁, v₁) for the vertex 221, (u₂, v₂) for the vertex 222 and (u₃, v₃) for the vertex 223. Following the convention of the bottom-left corner having an absolute coordinate of (0,0) and the top-right corner having an absolute coordinate of (1,1), the vertices of the mapped triangle 225 can be assigned the values: (0, 0) for the vertex 221, (0.25, 1) for the vertex 222 and (1,0) for the vertex 223 in texture space.

The result of applying the texture image 100 to the triangular surface 210 is illustrated by the textured triangular surface 230. The texture image 100 is distorted because the triangular surface 210 and its mapping onto the texture image, mapped triangle 225, are dissimilar.

In some examples, a 3D print file may comprise a 3D model that comprises a triangular mesh. The triangular mesh may be generated from multiple triangular surfaces 210, as illustrated in FIG. 2a. From the 3D print file, a 3D printer may generate a 3D print model. The characteristics or features of the 3D print model may be determined by the characteristics of the 3D printer and the contents of the 3D print file i.e. the 3D model and the texture image.

The 3D print model that is generated from the 3D model of the 3D print file is used by the 3D printer to manufacture the 3D object. The 3D print file generated by the 3D printer is unique to the 3D printer, as it takes into consideration the printing resolution of the 3D printer.

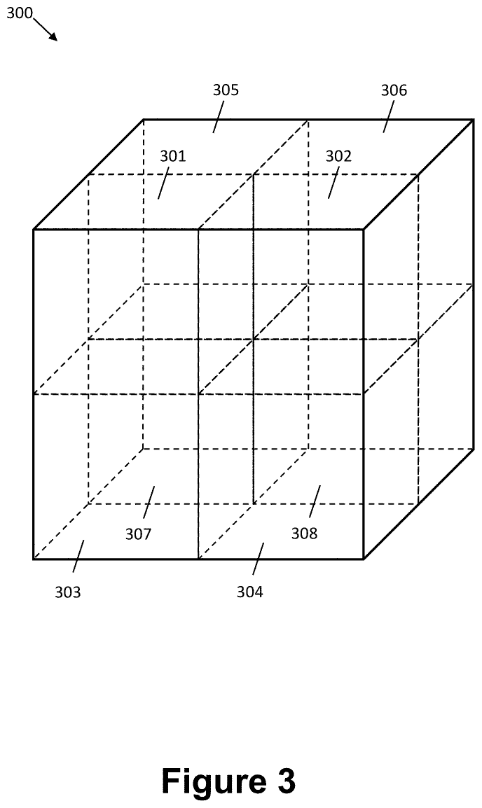

FIG. 3 is a schematic representation of an example of a 3D print model 300. Analogous to pixels in a picture image and texels in a texture image, a 3D print model 300 comprises a 3D grid of volume pixels, which may be referred to as volume elements or voxels 301, 302, 303, 304, 305, 306, 307, 308.

In order to manufacture a 3D object, a 3D printer may utilize such a 3D print model 300. The voxels 301-308 of the 3D print model 300 may, in some cases, be considered to be the fundamental printing unit of the 3D printer. Therefore, the minimum size of a voxel may be referred to as the printing resolution of a 3D printer. In some examples, the dimensions of a voxel may not be equal e.g. the x, y and/or z dimensions of the voxel may be different. Furthermore, the voxels of a 3D print model may not have the same dimensions throughout the 3D print model.

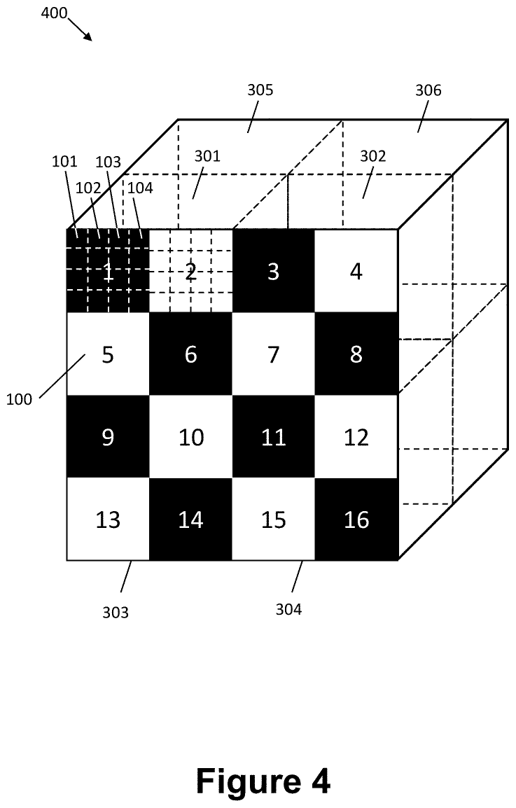

FIG. 4 is a schematic representation of an example of mapping a texture image 100 to a 3D print model 400. A texture image 100 may be mapped onto a 3D print model 400, whereby the texture image 100 is mapped to the front surface of the voxels 301-304. As previously described in relation to FIG. 1, the texture image 100 comprises texels 101, 102 etc. and has a resolution 16×16. The 3D print model 400 comprises voxels 301, 302 etc. and has a resolution 2×2×2. Note the same absolute size of the texture image 100 and the combined front surface of the voxels 301-304 of the 3D print model 400 in this example.

The voxels 301-304 with the texture image 100 mapped to their front surface are considered to be surface voxels. The value of one or more texels may be applied to the whole voxel. For example, if the parameters of the texture image are an RGB colour model, the voxels 301-304 may be formed as red, green or blue voxels during the printing process. The voxels 305-308 which do not have the texture image 100 mapped to any of their surfaces are considered bulk voxels and may not have a texture value applied to them. In some examples, the bulk voxels adjacent to the surface voxels may have a texture value applied to them.

Applying the texture image 100 to the front surface of the 3D print model 400, 8×8 texels of the texture image 100 are mapped to the surface of a single voxel 301. Similarly, 8×8 texels of the texture image 100 are mapped to the surface of voxel 302. This leads to the scenario where there are multiple texels mapped to the same voxel i.e. the resolution of the texture image is higher than the 3D printing resolution. Printing a 3D object whereby multiple texels are mapped to a single voxel may lead to unreliable 3D printing outcomes.

Matching the resolution of the texture image to the 3D printing resolution i.e. matching the size of the texels to the size of the voxels may reduce artefacts in the resulting printed 3D object.

Prior to the 3D printing process, the texture image may be pre-processed to generate a selection of lower resolution texture images. The lower resolution texture images may then be evaluated to select an appropriate lower resolution texture image for the resolution of the 3D printer. For each voxel of the 3D print model, an appropriate lower resolution texture image may be selected. For example, an appropriate lower resolution texture image may be a texture image where the size of the texel of the lower resolution texture image is closest to the size of the voxel of the 3D print model.

In FIG. 4, the texels of the texture image 100 are mapped to the front surface of the voxels 301-304 with an angle between the texture image 100 and the front surface of the voxels 301-304 of zero degrees. In some examples, the mapping of a texture image to the surface of voxels may be at a different angle i.e. the orientation of the texture image relative to the voxels may not be zero degrees. Different orientations of the texture image relative to the voxels may result in different lower resolution texture images to be selected.

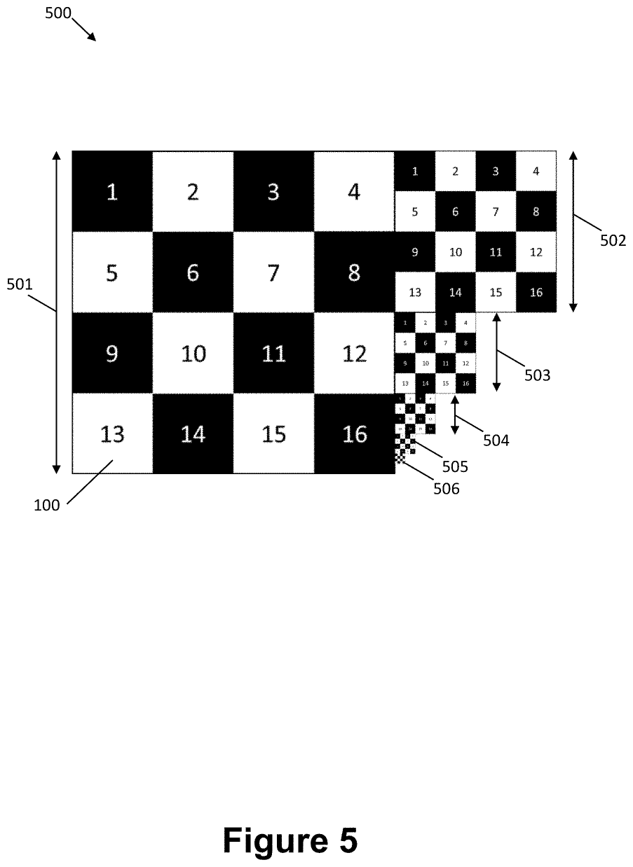

FIG. 5 is an example of a mipmapped texture image 500. From the original texture image 100, lower resolution texture images may be generated. The process of generating isotropically lower resolution texture images may be referred to as mipmapping. Isotropically mipmapping lower resolution texture images creates lower resolution texture images with equal absolute dimensions in x and y directions. The lower resolution texture images are created whereby each successive lower resolution version has half the resolution in both the x and y dimension than the previous version. In other words, each lower resolution version has a resolution of ½² or ¼ than the previous version. In order to correctly mipmap the original texture image 100, the number of texels of the original texture image 100 in the x and y dimension may be a power of two.

An original texture image 100 may have, for example, dimensions or a resolution 501 of 1024×1024. Mipmapping the original texture image 100 can produce a lower resolution texture image with a resolution 502 of 512×512. Similarly, this lower resolution texture image, may be further mipmapped to produce a lower resolution texture image with a resolution 503 of 256×256. This process may repeat, to create successive lower and lower resolutions 504, 505, 506 of the texture image e.g. 128×128, 64×64, 32×32 etc. The mipmapping process may repeat until a lower resolution texture image with a resolution of 1×1 is produced, or the process may stop at a pre-defined resolution level e.g. the lower resolution 506 of 32×32 of the texture image.

Therefore, a selection of lower resolution texture images or, equivalently, a selection of texture images with larger sized texels, are generated. For each voxel of the 3D print model, the most appropriate lower resolution texture image may be selected, based on the size of the texel and the size of the voxel. The selected lower resolution texture image may have the closest ratio of 1:1 for the size of the texel to the size of the voxel.

In some examples, the texture images produced by the mipmapping process may include the original texture image 100 along with the lower resolution texture images. In such cases, the original texture image may be determined to be the most appropriate texture image for selection.

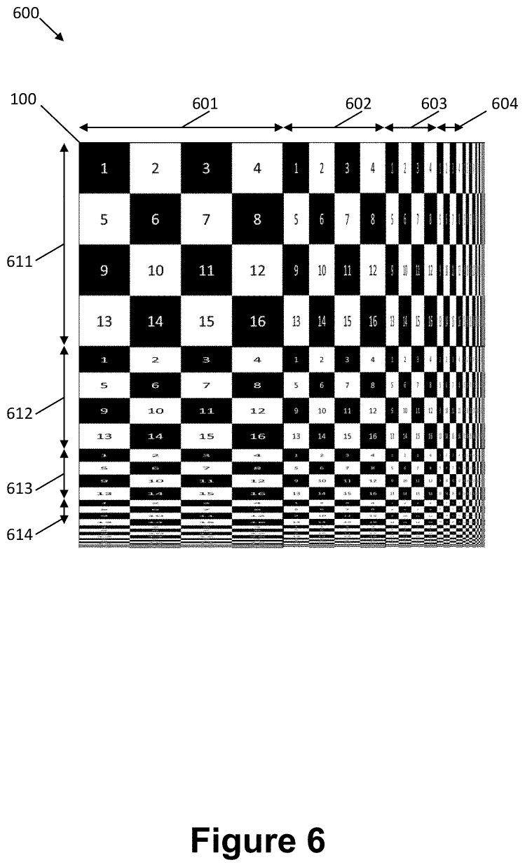

FIG. 6 is an example of an anisotropically mipmapped texture image 600. From the original texture image 100, lower resolution texture images may be generated. The process of generating anisotropically lower resolution texture images may be referred to as anisotropic mipmapping. Anisotropically mipmapping the original texture image 100 creates lower resolution texture images with both equal and unequal dimensions in x and y dimensions. The lower resolution texture images are created whereby each successive lower resolution version has half the resolution in x and/or y dimension that the previous version.

The original texture image 100 may have, for example a resolution of 1024×1024. The resolution of 1024 in the x dimension is shown by 601 and the resolution of 1024 in the y dimension is shown by 611. Anisotropically mipmapping the original texture image can produce lower resolution texture images with resolutions 602, 603, 604 etc. in the x dimension of 512, 256, 128 etc. Similarly, lower resolution texture images are produced with resolutions 612, 613, 614 etc. in the y dimension of 512, 256, 128 etc. Therefore, lower resolution texture images are created with lower resolution versions with equal and unequal dimensions in the x and y dimension e.g. 1024×512, 1024×256, 512×512, 256×512 etc.

The process of anisotropic mipmapping generates a selection of lower resolution texture images whereby the dimensions of the texels of the lower resolution texture images may not be equal in the x, y and/or z dimension. Therefore, for voxels with unequal dimensions in the x, y and/or z dimension, an appropriate lower resolution texture image may always be selected, whereby the size of the texel and the size of the voxel are as equal (as close to the ratio 1:1) as possible.

In some examples, the texture images produced by the anisotropic mipmapping process may include the original texture image 100 along with the lower resolution texture images. In such cases, the original texture image may be determined to be the most appropriate texture image for selection.

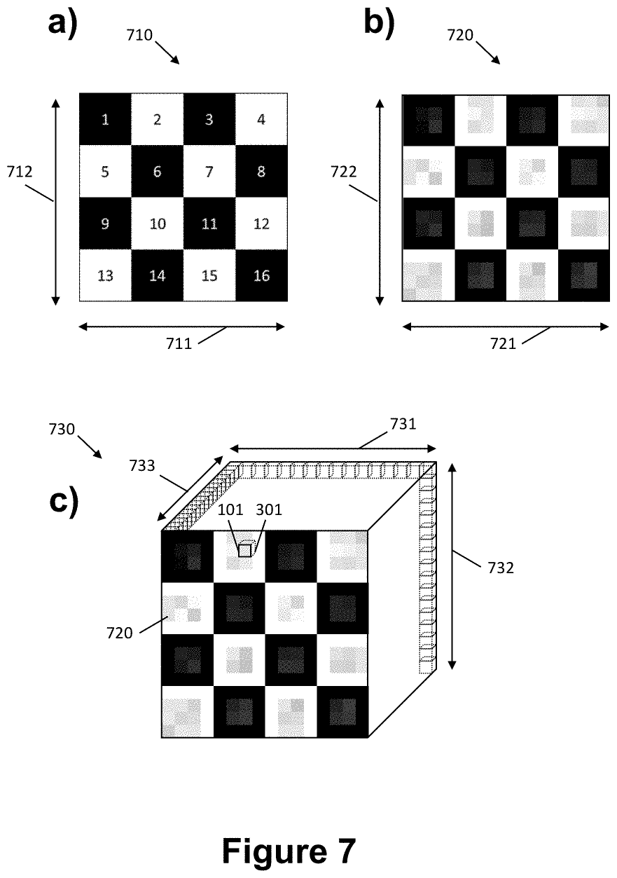

FIGS. 7a-c are schematic representations of an example of mapping a lower resolution texture image 720 to a 3D print model 730. FIG. 7a shows the original texture image 710 with a resolution in the x dimension 711 of 1024 texels and a resolution in the y dimension 712 of 1024 texels i.e. a resolution 1024×1024. By mipmapping the original texture image, one or more lower resolution texture images may be generated.

FIG. 7b shows an example of one such lower resolution texture images 720 with a resolution in the x dimension 712 of 16 texels and a resolution the y dimension of 16 texels i.e. a resolution 16×16.

FIG. 7c shows a 3D print model 730 with a resolution in the x dimension 731 of 16 voxels, a resolution in the y dimension 732 of 16 voxels, and a resolution in the z dimension 733 of 16 voxels i.e. a resolution of 16×16×16. Note the same absolute size of the texture image 710 and the front surface of the 3D print model 730 in this example.

From all the lower resolution texture images generated by mipmapping the texture image 710, the lower resolution texture image 720 with a resolution of 16×16 may be selected, based on the size of the texels of the texture image 720 and the size of the voxels of the 3D print model 730. FIG. 7c shows a selected texel 101 illustrated by a solid line and its corresponding voxel 301 illustrated by a dashed line. As the size of the texel 101 and the size of the voxel 301 match, the lower resolution texture image 720 may be selected. From the selected lower resolution texture image 720, a texture value for the voxel 301 may be determined. The texture value for the voxel may be calculated from the texel 301 of the selected lower resolution texture image 720.

In some examples, a texture image may be mapped to voxels of a 3D print model at an angle i.e. the texture image is orientated with respect to the surface of the voxels. In such a scenario, different orientations of the texture image relative to the voxels may result in the selection of different lower resolution texture images.

In some examples, multiple lower resolution texture images may be selected to determine the texture value for the voxel. If the size of a voxel of the 3D print model is between the sizes of two consecutive lower resolution texture images, then the two consecutive lower resolution texture images may be selected. The texture value for the voxel may then be interpolated from the two selected consecutive lower resolution texture images.

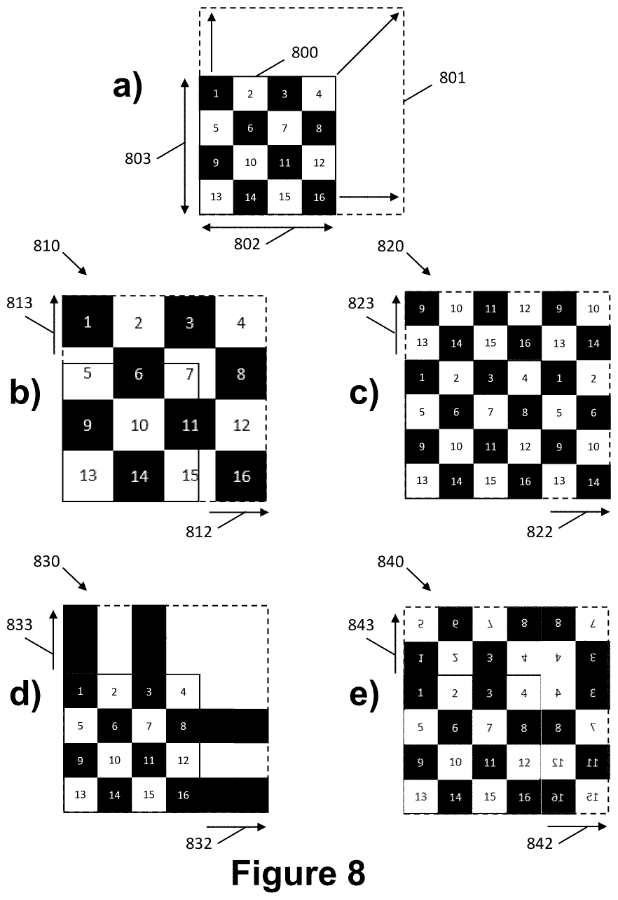

FIGS. 8a-e are schematic representations of examples of extending texture images 810, 820, 830, 840. FIG. 8a shows a texture image 800 with an x dimension 802 and a y dimension 803. The dimensions or size of the texture image 800 may be modified to create an extended texture image with a different, pre-determined, size 801. In other words, the number of texels in the x and y dimension 802, 803 may be extended to create an extended texture image. The original texture image 800 may be extended and the dimensions of the extended texture image given by the dashed line 801.

In some examples, the number of texels of the texture image in one dimension 802, 803, may be extended to the closest power of two. For example, if the dimensions (or number of texels) of a texture image is 500×1000, then the texture image may be extended to 512×1024. Extension of the texture image may be performed prior to generating the lower resolution texture images. In such cases, the dimensions of the extended texture image are ready to be isotropically and/or anisotropically mipmapped.

In some examples, extension of the original texture image 800 to the size 801 of the extended texture image may follow a pre-determined rule. In some examples, a 3D print file comprising the texture image 801 may additionally comprise a pre-determined rule for extending the texture image. FIGS. 8b-c show examples of pre-determined rules for extending a texture image 800.

FIG. 8b illustrates scaling up the original texture image 800 to the required size 801 of the extended texture image. In the x dimension, the number of texels may increase from 802 to 812. Similarly, in the y dimension, the number of texels may increase from 803 to 813. In such a scenario, the original texture image 800 is scaled up so that the extended texture image 810 looks the same as the original texture image 800 but more texels are used to create the texture image.

FIG. 8c illustrates extending the original texture image 800 to the required size 801 by filling in the extra texels 822, 823 by wrapping the original texture image 800. In such a scenario, the texels of the original texture image 800 are tiled or wrapped to the required size of the extended texture image 820. In the x dimension, the number of texels increase from 802 to 822 and in the y dimension, the number of texels increases from 803 to 823. In each direction, the extra texels 822, 823 contain the same value of texels from the original texture image 800.

FIG. 8d illustrates extending the original texture image 800 to the required size 801 by filling in the extra texels 832, 833 by clamping the original texture image 800. In such a scenario, the texels on the edge of the original texture image 800 are repeated to the required size of the extended texture image 830. In the x dimension, the number of texels increase from 802 to 832 and in the y dimension, the number of texels increases from 803 to 833. In each direction, the extra texels 832, 833 are repetitions of the texels on the edge of the original texture image 800 to the required size 801.

FIG. 8e illustrates extending the original texture image 800 to the required size 801 by filling in the extra texels 842, 843 by mirroring the original texture image 800. In such a scenario, the texels of the original texture image 800 are mirrored along the edge of the original texture image 800 to the required size of the extended texture image 840. In the x dimension, the number of texels increase from 802 to 842 and in the y dimension, the number of texels increases from 803 to 843. In each direction, the extra texels 842, 843 contain the mirrored value of texels from the original texture image 800.

In some examples, the pre-determined rule for extending the texture image may be different in the x dimension to the y dimension.

In some examples, the closest power of two to the number of texels in the x and/or y direction may be smaller. i.e. extending the texture image 800 to the closest power of two may result in a smaller texture image than the original texture image 800. In such cases, the original texture image 800 may be scaled down i.e. the smaller texture image looks the same as the original texture image 800 but fewer texels are used to create the smaller texture image. In other cases, the original texture image 800 may be cropped i.e. the number of texels greater than the closest power of two are deleted from the original texture image 800 to create the smaller texture image.

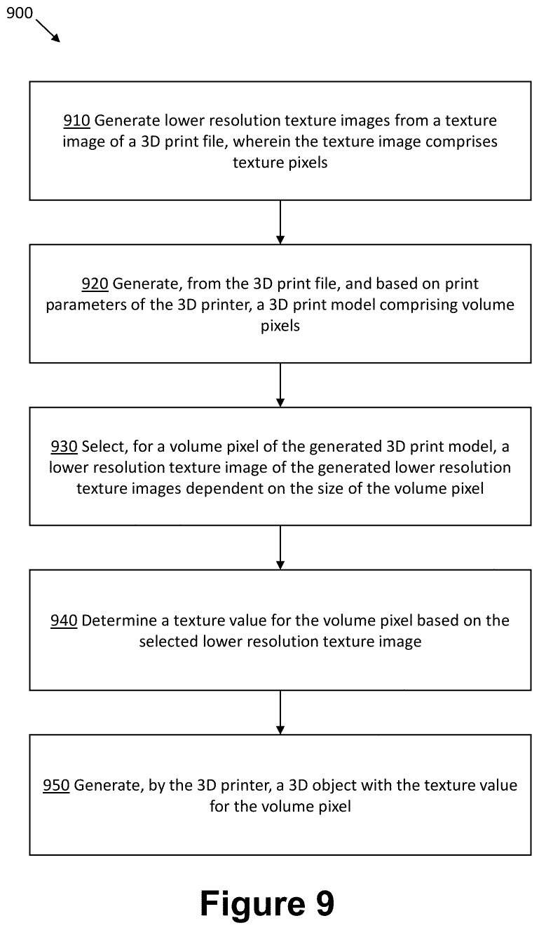

FIG. 9 is a block diagram 900 of an example of a method in a 3D printer. In block 910, lower resolution texture images from a texture image of a 3D print file are generated. The texture image may comprise texture pixels or texels.

In some examples, the lower resolution texture images are generated by mipmapping. In other examples, the lower resolution texture images are generated by anisotropic mipmapping. Lower resolution texture images comprise larger sized texels.

In some examples, prior to generating the lower resolution texture images, the number of texture pixels of the texture image in one dimension is extended to the closest power of two. Extending the texture image to the closest power of two in one or two dimensions simplifies the mipmapping procedure as each successive lower resolution texture image is a power of two smaller than the previous lower resolution texture image.

In some examples, extending the texture image to the closest power of two follows pre-determined rules. Such pre-determined rules may be determined by the 3D print file that contains the texture image. Example pre-determined rules may be, but are not limited to, scaling, wrapping, clamping and/or mirroring. In some examples, extending the texture image may follow different pre-determined rules in the x and y dimension.

In block 920, a 3D print model is generated from the 3D print file, based on print parameters of the 3D printer. The 3D print model may comprise volume pixels or voxels.

In some examples, the 3D print file comprises a 3D model of a 3D triangular mesh. The texture pixels of the texture image may be mapped onto the vertices of the 3D triangular mesh using the texture coordinates associated with the vertices of the 3D triangular mesh. Mapping of the texture pixels to the 3D triangular mesh may be performed prior to generating the 3D print model by the 3D printer.

In block 930, a lower resolution texture image of the generated lower resolution texture images is selected for a volume pixel of the generated 3D print model. The selected lower resolution texture image may be dependent on the size of the volume pixel.

In some examples, the selection may be further dependent on the size of the texture pixel in the selected lower resolution texture image. In some examples, a different lower resolution texture image may be selected for a different volume pixel. In some examples, multiple selected lower resolution texture images may be used to determine the texture value for the volume pixel.

In some examples, the selection of the lower resolution texture image may be determined by the orientation of the texture image with respect to the 3D print model. In such cases, the lower resolution texture image may be selected based on the orientation of the texture image with respect to the voxels of the 3D print model.

In block 940, a texture value for the volume pixel is determined, based on the selected lower resolution texture image. The texture value for the volume pixel may be calculated from a texture pixel of the selected lower resolution texture images.

In block 950, a 3D object is generated, by the 3D printer, with the texture value for the volume pixel. The texture image is thus applied to the 3D object. In some examples, the textures values for all volumes pixels may be determined prior to generating the 3D object by the 3D printer. In other examples, the texture value for each volume pixel is determined as the 3D object is generated by the 3D printer.

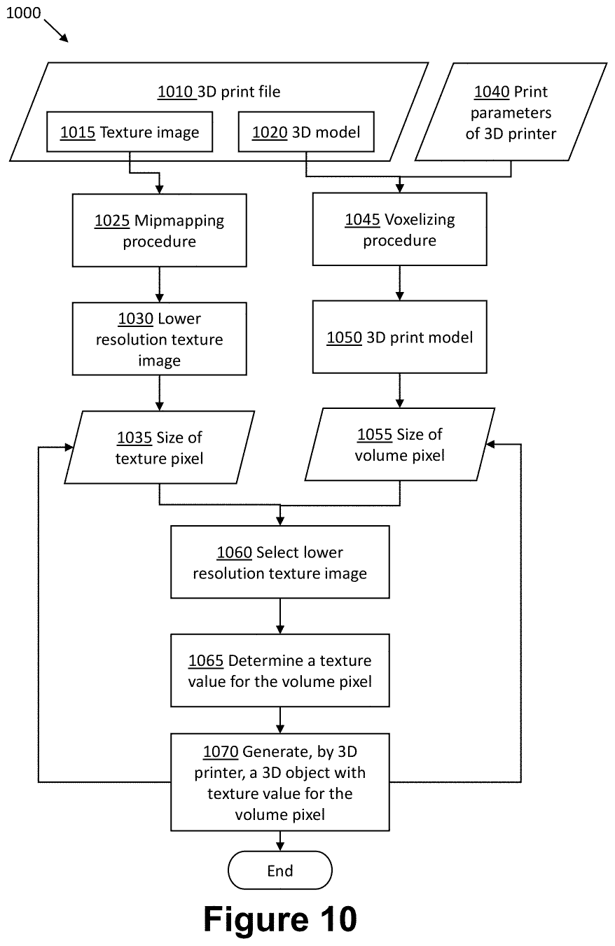

FIG. 10 is an example of a flowchart 1000 of a method in a 3D printer. A 3D print file 1010 may comprise a 3D model 1020 and a texture image 1015. The texture image 1015 may be inputted into a mipmapping procedure 1025. The mipmapping procedure 1025 may output a lower resolution texture image 1030. The lower resolution texture image 1030 comprises texture pixels or texels. From the lower resolution texture image 1030, the size of a texture pixel may be determined 1035.

The 3D printer may have characteristic print parameters 1040. The print parameters 1040 and the 3D model 1020 may be inputted into a voxelizing procedure 1045. The voxelizing procedure 1045 may generate a 3D print model 1050 which is characteristic of the 3D printer. The 3D print model comprises volume pixels or voxels. From the 3D print model 1050, the size of a volume pixel may be determined 1055.

For the volume pixel, a lower resolution texture image is selected at block 1060 from the generated lower resolution images 1030. The selection of the lower resolution texture image may be based on the size of the volume pixel 1055. The selection may be further based on the size of the texture pixel 1035. The selection may be further based on the orientation of the texture image 1015 with respect to the 3D print model 1050.

The selected lower resolution texture image is used at block 1065 to determine a texture value for the volume pixel. The texture value for the volume pixel may be calculated from the texture pixel of the selected lower resolution texture image. A 3D object may then be generated 1070, by the 3D printer, with the texture value for the volume pixel.

The process may follow a path from block 1070 to 1055, whereby the size of another volume pixel is determined. Similarly, the process may follow a path from block 1070 to 1035, whereby the size of another texture pixel may be determined. Blocks 1060, 1065, 1070 may be repeated, in order to select a lower resolution texture image, determine the texture value for the other volume pixel and generate, by the 3D printer, the 3D object with the texture value for the volume pixel. The process may be repeated for a further volume pixel until a texture value has been determined for all voxels of the 3D print model with a texture image mapped to them. In some examples, the texture values for all the voxels may not be applied to the 3D object by the 3D printer until the texture values for all the volume pixels have been determined.

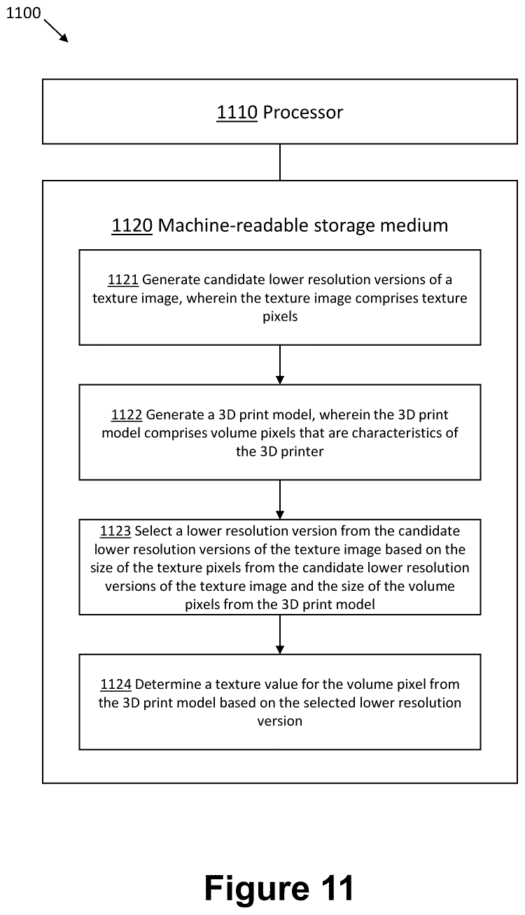

FIG. 11 is an example of a schematic diagram 1100 of a processor 1110 and a machine-readable storage medium 1120 for performing a method in a 3D printer. The machine-readable storage medium 1120 comprises computer-readable instructions 1121-1124 for performing a method in a 3D printer which, when executed by at least one processor 1110, cause the at least one processor 1110 to perform a method according to examples described herein. The computer-readable instructions 1121-1124 may be retrieved from a machine-readable media, for example any media that can contain, store, or maintain programs and data for use by or in connection with an instruction execution system. In this case, machine-readable media can comprise any one of many physical media such as, for example, electronic, magnetic, optical, electromagnetic, or semiconductor media. More specific examples of suitable machine-readable media include, but are not limited to, a hard disk drive, a random-access memory (RAM), a read-only memory (ROM), an erasable programmable read-only memory, or a portable disc.

At block 1121 the instructions cause the processor 1110 to generate candidate lower resolution versions of a texture image, wherein the texture image comprises texels or texture pixels.

At block 1122 the instructions cause the processor 1110 to generate a 3D print model, wherein the 3D print model comprises voxels or volume pixels that are characteristic of the 3D printer.

At block 1123 the instructions cause the processor 1110 to select a lower resolution from the candidate lower resolution versions of the texture image, the selection based on the size of the texture pixels from the candidate lower resolution versions of the texture image and the size of the volume pixels from the 3D print model; and

At block 1124 the instructions cause the processor 1110 to determine a texture value for the volume pixel from the 3D print model based on the selected lower resolution version.

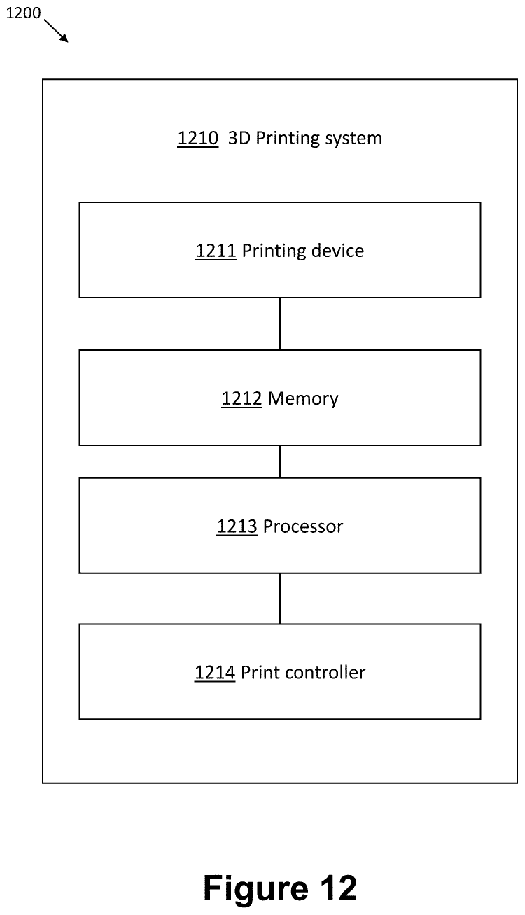

FIG. 12 is an example of a schematic diagram 1200 of a 3D printing system 1210. The 3D printing system 1210 comprises a printing device 1211 to apply a texture image to a 3D object to be generated in a 3D print process. The 3D printing system 1210 further comprises a memory 1212 to store data representing a 3D print file comprising the texture image. The 3D printing system 1210 comprises a processor 1213 to generate lower resolution texture images from the texture image; generate a 3D print model from the 3D print file, based on print parameters from the 3D printer; select, from the lower resolution texture images, a lower resolution texture image for a volume pixel of the generated 3D print model based on the size of the volume pixel; and determine, based on the selected lower resolution texture image, a texture value for the volume pixel. The 3D printing system 1210 further comprises a print controller 1214 to apply the texture value to the volume pixel of the 3D print model and cause the printing device to apply the texture value for the volume pixel to the 3D object in the 3D print process.

1. A method in a three-dimensional printer comprising:
generating a lower resolution texture image from a texture image of a three-dimensional print file, wherein the texture image comprises texture pixels;
generating, from the three-dimensional print file, and based on print parameters of the three-dimensional printer, a three-dimensional print model comprising volume pixels;
selecting, for a volume pixel of the generated three-dimensional print model, a lower resolution texture image of the generated lower resolution texture images dependent on a size of the volume pixel; and
determining a texture value for the volume pixel based on the selected lower resolution texture image.

2. A method according to claim 1, wherein selecting a lower resolution texture image is further dependent on a size of texture pixels in the selected lower resolution texture image.

3. A method according to claim 1, wherein selecting a lower resolution texture image is further dependent on an orientation of the texture image with respect to the three-dimensional print model.

4. A method according to claim 1, comprising selecting, for a different volume pixel of the generated three-dimensional print model, a different lower resolution texture image of the generated lower resolution texture images dependent on a size of the different volume pixel; and determining a texture value for the different volume pixel based on the selected different lower resolution texture image.

5. A method according to claim 1, wherein the three-dimensional print file comprises a three-dimensional triangular mesh.

6. A method according to claim 5, wherein texture pixels of the texture image are mapped onto vertices of the three-dimensional triangular mesh.

7. A method according to claim 1, wherein the lower resolution texture images are generated by mipmapping.

8. A method according to claim 1, wherein the lower resolution texture images are generated by anisotropic mipmapping.

9. A method according to claim 1, wherein prior to generating the lower resolution texture images, the number of texture pixels of the texture image in one dimension is extended to the closest power of two.

10. A method according to claim 9, wherein extending the texture image follows a pre-determined rule.

11. A method according to claim 1, wherein the determining a texture value for the volume pixel is based on a further selected lower resolution texture image of the generated lower resolution texture images.

12. A method according to claim 11, wherein the texture value for the volume pixel is calculated from texture pixels of the selected and further selected lower resolution texture images.

13. A method according to claim 1, further comprising generating, by the three-dimensional printer, a three-dimensional object with the texture value for the volume pixel.

14. A non-transitory machine-readable storage medium encoded with instructions executable by a processor in a three-dimensional printer, the machine-readable storage medium comprising:
instructions to generate candidate lower resolution versions of a texture image, wherein the texture image comprises texture pixels;
instructions to generate a three-dimensional print model, wherein the three-dimensional print model comprises volume pixels that are characteristic of the three-dimensional printer;
instructions to select a lower resolution version from the candidate lower resolution versions of the texture image, the selection based on:
a size of the texture pixels from the candidate lower resolution versions of the texture image; and
a size of the volume pixels from the three-dimensional print model; and
instructions to determine a texture value for the volume pixel from the three-dimensional print model based on the selected lower resolution version.

15. A printing system comprising:
a printing device to apply a texture image to a three-dimensional object to be generated in a three-dimensional print process;
a memory to store data representing a three-dimensional print file comprising the texture image;
a processor to:
generate lower resolution texture images from the texture image;
generate a three-dimensional print model from the three-dimensional print file, based on print parameters from the three-dimensional printer;
select, from the lower resolution texture images, a lower resolution texture image for a volume pixel of the generated three-dimensional print model based on a size of the volume pixel; and
determine, based on the selected lower resolution texture image, a texture value for the volume pixel; and
a print controller to:
apply the texture value to the volume pixel of the three-dimensional print model; and
cause the printing device to generate, in the three-dimensional print process, the three-dimensional object with the texture value for the volume pixel.

16. A printing system according to claim 15, wherein to select the lower resolution texture image is further dependent on a size of texture pixels in the selected lower resolution texture image.

17. A printing system according to claim 15, wherein selecting a lower resolution texture image is further dependent on an orientation of the texture image with respect to the three-dimensional print model.

18. A printing system according to claim 15, comprising selecting, for a different volume pixel of the generated three-dimensional print model, a different lower resolution texture image of the generated lower resolution texture images dependent on a size of the different volume pixel; and determining a texture value for the different volume pixel based on the selected different lower resolution texture image.

19. A printing system according to claim 15, wherein the three-dimensional print file comprises a three-dimensional triangular mesh.

20. A printing system according to claim 19, wherein texture pixels of the texture image are mapped onto vertices of the three-dimensional triangular mesh.
